(19) United States
(12) Patent Application Publication
(10) Pub. No.: US 2026/0127088 A1
(43) Pub. Date: May 7, 2026

(54) ADAPTIVE RESOURCE SCHEDULING OPTIMIZATION

(71) Applicant: International Business Machines Corporation, Armonk, NY (US)

(72) Inventors: Alaa S. Youssef, Valhalla, NY (US); Asser Nasreldin Tantawi, Somers, NY (US); Nelson Mimura Gonzalez, Westchester, NY (US); Volkmar Uhlig, Austin, TX (US)

(73) Assignee: International Business Machines Corporation, Armonk, NY (US)

(21) Appl. No.: 18/934,362

(22) Filed: Nov. 1, 2024

(51) Int. Cl. G06F 11/34; G06F 9/50

(52) U.S. Cl. CPC G06F 11/3433; G06F 9/5044; G06F 11/3442

(57) ABSTRACT

An embodiment generates a performance profile for each configuration of a set of possible configurations, each configuration representing a pairing between an application and a portion of computing resource units for deployment of the application. The embodiment computes a performance approximation formula based on one or more performance profiles generated. The embodiment computes a performance metric for each configuration of the set of possible configurations based on the performance approximation formula. The embodiment constructs an optimization problem representing each configuration of the set of possible configurations. The embodiment solves the optimization problem according to a defined optimization goal and the performance metric of each configuration. The embodiment produces an optimal number of computing resource units to deploy each application and deploys each application over a portion of the set of possible configurations corresponding to the optimal number of computing resource units produced by the optimization problem solution.

### BACKGROUND

The present invention relates generally to computer resource capacity planning and dynamic resource allocation. More particularly, the present invention relates to a method, system, and computer program for adaptive resource scheduling optimization.

In the context of cloud computing, resource allocation involves the distribution of computing resources (e.g., CPU, GPU, memory, storage, bandwidth, etc.) among multiple users or applications. In some instances, resource scheduling algorithms are developed to determine how and when resources are allocated among different tasks or applications. Some of these existing algorithms consider factors such as workload, priority, and resource availability to optimize resource utilization and performance.

Cloud computing systems may be designed to be elastic, allowing resources to be automatically scaled up or down based on demand. Dynamic resource allocation techniques aim to provide adequate resources whenever required while maximizing efficiency of distributing available resources. Load balancing techniques may be utilized to distribute incoming network traffic or workload across multiple servers or resources to ensure optimal resource utilization and prevent overloading of any single resource. Further, continuous monitoring of resource usage and performance metrics may also help in identifying bottlenecks, optimizing resource utilization, and ensuring service level agreements (SLAs) are met.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries. Accordingly, AI systems may be designed for various tasks that traditional computer systems were previously incapable.

An Artificial Neural Network (ANN)—also referred to simply as a neural network-is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex. An ANN today might have upwards of billions of interconnected “neuron” processor units, though may be trained using a far fewer number of dedicated hardware processor units (e.g., GPUs). Further, ANNs can be designed to uncover relationships between previously unknown factors.

Large Language Models (LLMs) necessitate significantly more computer resources compared to traditional computing systems due to their complex architecture and massive scale. LLMs are characterized by deep neural networks with millions or even billions of parameters, requiring substantial computational power for training and inference tasks. Traditional computing systems, on the other hand, typically operate on smaller datasets and simpler models, resulting in lower resource requirements. The sheer size and complexity of LLMs demand high-performance computing resources, including advanced CPUs, GPUs, or specialized hardware like TPUs, to handle the intensive computational workload effectively. Moreover, LLMs consume large amounts of memory for processing vast datasets and model parameters, necessitating efficient memory management techniques to optimize resource allocation. The intricate nature of LLMs, coupled with their extensive data processing and model complexity, is responsible for heightened demand for computer resources beyond what traditional computing systems typically entail.

### SUMMARY

The illustrative embodiments provide for dynamic computer resource allocation optimization. An embodiment includes generating a performance profile for each configuration of a set of possible configurations, such that each configuration represents a pairing between an application and a portion of computing resource units for deployment of the application. The embodiment also includes computing a performance approximation formula based on one or more performance profiles generated. The embodiment also includes computing a performance metric for each configuration of the set of possible configurations based on the performance approximation formula. The embodiment also includes constructing an optimization problem representing each configuration of the set of possible configurations. The embodiment also includes solving the optimization problem according to a defined optimization goal and the performance metric of each configuration. The embodiment also includes producing an optimal number of computing resource units to deploy the application and deploys the application over a portion of the set of possible configurations corresponding to the optimal number of computing resource units produced.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of an example computing environment in accordance with an illustrative embodiment;

FIG. 2 depicts a block diagram of an example computing environment in accordance with an illustrative embodiment;

FIG. 3 depicts a block diagram of an example dynamic resource optimizer software module in accordance with an illustrative embodiment;

FIG. 4 depicts a block diagram of an example system architecture in accordance with an illustrative embodiment;

FIG. 5 depicts a block diagram of an example process for capacity planning and dynamic resource allocation in accordance with an illustrative embodiment;

FIG. 6 depicts a flow chart of a process for resource allocation scheduling in accordance with an illustrative embodiment; and

FIG. 7 depicts a flow chart of an example process for dynamic computer resource allocation optimization in accordance with an illustrative embodiment.

### DETAILED DESCRIPTION

The inefficiencies of currently existing methods of autoscaling to meet workload demands stem are due to various reasons. For example, many existing autoscaling methods are entirely reactive, meaning they respond to changes in workload demands after changes in workload demand have already occurred. This reactive approach can lead to delays in scaling up or down resources, resulting in performance bottlenecks during peak demand periods or underutilization during low-demand periods. Further, some autoscaling methods rely solely on historical data or simple threshold-based triggers to adjust resource allocation. Without predictive capabilities to anticipate future workload patterns, these methods may struggle to scale resources proactively and efficiently.

Accordingly, inefficient autoscaling methods may lead to over-provisioning, where excess resources are allocated beyond what is necessary, resulting in increased costs and resource wastage. Conversely, under-provisioning can occur when resources are scaled back too aggressively, leading to performance degradation and potential service disruptions. Existing autoscaling methods may use static or simplistic scaling policies that do not account for the dynamic nature of modern workloads. Without adaptive scaling policies that consider factors such as application performance metrics, cost optimization, and service level agreements, autoscaling decisions may not align with the actual needs of the system.

Further, some autoscaling methods focus solely on scaling based on a single metric, such as CPU utilization or request rate, without considering other relevant factors. Multi-dimensional scaling, which takes into account various performance metrics and resource constraints simultaneously, may aid optimizing resource allocation in complex computing environments. In some cases, autoscaling methods may not consider the heterogeneity of resources available in the environment, leading to suboptimal resource allocation decisions. Failure to match workload demands with the most suitable resources can result in performance inefficiencies and increased operational costs.

Accordingly, these inefficiencies described above may be addressed at least in part by the development of more sophisticated techniques that leverage predictive analytics, adaptive scaling policies, multi-dimensional scaling approaches, and/or intelligent resource allocation strategies. By overcoming the inefficiencies of currently existing methods, systems and organizations can achieve more efficient and cost-effective computer resource management to meet dynamic workload demands effectively. The following disclosure addresses the deficiencies described above and includes a deep learning-based technique to address a resource constrained multi-project scheduling problem in a multi-system service environment.

Accordingly, the present disclosure addresses the deficiencies described above by providing a process (as well as a system, method, machine-readable medium, etc.) that develops a dynamic resource optimizer to determine optimal capacity planning and computer resource allocation for a given system. In an embodiment, the dynamic resource optimizer is a software module designed to optimize resource allocation within a computing environment. The inputs to the dynamic resource optimizer may include data such as current workload demands, performance metrics of computing resources, historical usage patterns, and service level objectives (SLOs). Additionally, the dynamic resource optimizer may receive inputs related to the characteristics of software applications, such as computational requirements, memory usage, and input-output patterns. By analyzing these inputs, the dynamic resource optimizer generates outputs that include optimized resource allocation strategies, scaling decisions, and recommendations for adjusting resource utilization based on workload fluctuations. The outputs of the dynamic resource optimizer may provide efficient resource utilization, meet performance objectives, and enhance system scalability and responsiveness in response to changing workload demands.

There are currently no existing systems or methods that consider computer hardware characteristics and software application characteristics to develop an optimal hardware configuration to use for deployment of the software application according to a specified optimization goal. In an embodiment, the optimization goal may include minimizing cost for deployment of an application using a particular computer hardware configuration. However, the use of this example only meant to be illustrative, and the optimization goal may include other types of specified optimization goals, such as for example, minimizing power consumption for deployment of an application using a particular computer hardware configuration. In some embodiments, the specified optimization goal includes any optimization goal specified by a user having sufficient privileges.

In an embodiment, the system may include a dynamic resource optimizer module configured to allocate an optimally determined portion of computer resources (i.e., computing resource units) for deployment of one or more software applications. In an embodiment, the dynamic resource optimizer module includes an analyzer module, a predictor module, an estimator module, and an optimizer module. In an embodiment, the analyzer module is responsible for analyzing current workload demands, performance metrics of computing resources, and historical usage patterns to gain insights into the system's resource utilization and performance. In an embodiment, the predictor module utilizes predictive analytics and/or one or more machine learning algorithms to forecast future workload patterns and resource requirements based on historical data and current trends. In an embodiment, the estimator module calculates resource needs and capacity requirements, based at least in part on the predictions generated by the predictor module. In an embodiment, the optimizer module leverages the insights from the analyzer, predictor, and estimator modules to make informed decisions on resource allocation, scaling strategies, and/or optimization techniques.

In an embodiment, the system may include one or more deep learning mechanisms. At least one deep learning mechanism may be configured to solve an optimization problem given certain inputs. Further, at least one deep learning mechanism may be configured to inference changes in workload demand. In an embodiment, one or more deep learning algorithms may be trained to learn patterns and relationships from historical data to make informed decisions on dynamic resource allocation based on changes workload demand. In an embodiment, at least one deep learning mechanism may be configured, trained, fine-tuned, tailored, optimized, etc. to enable the system to consider subjective factors (e.g., SLO objectives, service class, etc.) in the dynamic resource allocation process. In an embodiment, the system includes an optimization mechanism. The optimization mechanism may be configured to set the goals for the system, which may include, for example, minimizing cost for executing a workload and/or minimizing power consumption for executing a workload. In an embodiment, the optimization algorithm may be learned from a sweep of the solution space of possible configurations and workloads of the optimizer, that is offline solutions of the solver to speed up the calculation during runtime.

The following description provides examples of embodiments of the present disclosure, and variations and substitutions may be made in other embodiments. Several examples will now be provided to further clarify various aspects of the present disclosure.

Example 1: A computer-implemented method that comprises generating a performance profile for each configuration of a set of possible configurations, each configuration representing a pairing between an application and a portion of computing resource units for deployment of the application. The method further comprises computing a performance approximation formula based on one or more performance profiles generated. The method further comprises computing a performance metric for each configuration of the set of possible configurations based on the performance approximation formula. The method further comprises constructing an optimization problem representing each configuration of the set of possible configurations. The method further comprises solving the optimization problem according to a defined optimization goal and the performance metric of each configuration. The method further comprises producing, based on results of solving the optimization problem, an optimal number of computing resource units to deploy each of a set of applications. The method further comprises deploying each application over a portion of the set of possible configurations corresponding to the optimal number of computing resource units produced for that application.

The above limitations advantageously enable the allocation of an optimal configuration of computer resources to use for deployment of one or more software applications. Each performance profile provides valuable insights into how an application will perform when deployed on a specific pairing of computing resource units. By analyzing these performance profiles, the method can make informed decisions about resource allocation and optimization. By deriving a formula that captures the performance characteristics of different configurations, the method can efficiently evaluate and compare the performance of various deployment scenarios. The performance metric serves as a quantitative measure of how well an application will perform on a specific configuration of computing resource units. By computing these metrics, the method can objectively assess the suitability of different deployment options. By constructing and solving an optimization problem, the method can systematically evaluate and compare the performance of different configurations to identify the most optimal deployment strategy. The results of solving the optimization problems are used to determine the optimal number of computing resource units required to deploy each application. By implementing the recommended resource allocations, the method can ensure that each application is deployed on the most suitable configuration to achieve optimal performance.

Example 2: The limitations of Example 1, wherein the defined optimization goal comprises minimizing deployment cost of the application. In some cases, the cost optimization component may interact with the optimization problem construction component to formulate optimization problems that specifically target the minimization of deployment costs. In some cases, the cost optimization component may impact the resource allocation component by influencing decisions on the optimal number of computing resource units to deploy for each application.

The above limitations advantageously incorporate cost considerations into the optimization goal, which enables the method to identify deployment strategies that are not only performance-efficient but also cost-effective. The cost optimization component may influence the optimization problem solving component by guiding the selection of resource allocation strategies that lead to cost reduction. By defining the optimization goal as minimizing deployment costs, the method can prioritize resource allocations that offer the best performance-to-cost ratio, ensuring efficient resource utilization.

Example 3: The limitations of Example 1, wherein the defined optimization goal comprises minimizing power consumption corresponding to deployment of the application. By considering power consumption as an optimization criterion, the method can leverage performance profiles to identify configurations that offer optimal performance while consuming minimal power. In some cases, the power consumption optimization component may influence the optimization problem solving component by guiding the selection of resource allocation strategies that lead to reduced power consumption.

The above limitations advantageously incorporate power consumption considerations into the optimization goal, which enables the method to prioritize and provide energy-efficient deployment strategies that help reduce operational costs and environmental impact. In some cases, the power consumption optimization component may collaborate with the performance profiling component to analyze how different configurations impact power consumption levels. This integration of power consumption considerations into the performance analysis process enables the method to make informed decisions about resource allocations that strike a balance between performance efficiency and energy efficiency. By setting minimizing power consumption as an primary optimization goal, the method can drive the optimization process towards deployment of applications not only optimized for performance but also for energy efficiency, contributing to overall sustainability and operational efficiency.

Example 4: The limitations of Example 1, wherein the generating a performance profile for each configuration of a set of possible configurations is based in part on an estimated workload demand corresponding to the application. In some cases, the method includes generating performance profiles for each configuration by incorporating estimated workload demands corresponding to the application. In some cases, the workload demand estimation component may interact with the performance approximation formula component to refine the computation of performance approximation formulas based on estimated workload demands. In some cases, the workload demand estimation component may influence the optimization problem construction component by providing insights into how workload demand changes impact the formulation of optimization problems for each configuration.

The above limitations advantageously consider esimated workload demands in the performance profiling stage to enable the method can create more accurate and representative performance profiles that reflect the expected resource requirements of the application under varying workloads. This integration of workload demand estimation enhances the precision of performance analysis and enables the method to make more informed decisions regarding resource allocations and optimization strategies. By incorporating workload demand data into the formula calculation process, the method can tailor the performance approximation formulas to better capture the performance characteristics of each configuration under specific workload scenarios. This refinement enhances the predictive accuracy of the performance approximation formulas, enabling the method to more effectively evaluate performance metrics and optimize resource allocations based on workload-specific considerations. Estimations of workload demands allows the method to design optimization problems that are more robust and adaptive to changing workload conditions, resulting in deployment strategies that are optimized not only for current performance requirements but also for anticipated workload demands.

Example 5: The limitations of Example 4, wherein the estimated workload demand is based in part on predicted workload demand change. In some cases, the computer-implemented method may include a predicted workload demand change component as part of the workload demand estimation process. This refinement allows the method to anticipate performance challenges that may arise due to workload fluctuations and proactively optimize resource allocations to ensure consistent performance levels across varying workload conditions. In some cases, the predicted workload demand change component may influence the optimization problem solving component by guiding the selection of resource allocation strategies that are robust to predicted workload changes. By factoring in predicted workload demand changes during the optimization process, the method can identify deployment strategies that are flexible and adaptive to future workload variations. This consideration enables the method to optimize resource allocations not only for current workload demands but also for expected changes in demand, ensuring that the deployed applications can efficiently scale and adapt to evolving workload requirements.

The above limitations advantageously enhance the accuracy of estimated workload demands by incorporating predictions of how workload demands are expected to change over time. By considering anticipated workload demand changes, the method can generate more dynamic and adaptive performance profiles that reflect the evolving resource requirements of the application. This integration of predicted workload demand changes enables the method to proactively adjust resource allocations and optimization strategies to accommodate future workload variations, leading to more resilient and future-proof deployment solutions. By incorporating insights into expected workload fluctuations, the method can create performance profiles that capture the application's performance characteristics under different workload scenarios, including anticipated changes in demand.

Example 6: The limitations of Example 5, wherein the predicted workload demand change is obtained by iteratively analyzing real-time workload demand corresponding to the application. In some cases, the computer-implemented method may include an iterative real-time workload analysis component to obtain predicted workload demand changes. This component enhances the accuracy of workload demand predictions by continuously analyzing real-time workload demand data corresponding to the application. By iteratively monitoring and analyzing real-time workload patterns, the method can dynamically adjust workload demand predictions based on real-time information. This iterative approach enables the method to adapt resource allocations and optimization strategies in real-time to align with changing workload demands, resulting in more responsive and adaptive deployment solutions.

The above limitations advantageously incorporate real-time workload data into the workload demand estimation process to enhance the accuracy of workload demand predictions by leveraging current workload trends and patterns. This integration of real-time data allows the method to continuously update and refine workload demand estimates, ensuring that deployment decisions are based on the most recent workload information available, leading to more precise resource allocations and optimization strategies. By leveraging real-time workload analysis, the method can proactively address workload fluctuations and ensure that deployed applications are continuously optimized for optimal performance under varying workload conditions.

Example 7: The limitations of Example 1, wherein producing an optimal number of computing resource units to deploy the application is based on meeting a service-level objective. In some cases, the method ensures that deployment of applications meets specific service-level objectives, such as response time, throughput, or availability, etc. In some cases, the service-level objective component may interact with the performance metric computation component to align resource allocations with service-level requirements. In some cases, the service-level objective component may influence the optimization problem solving component by guiding the selection of resource allocation strategies that optimize performance to meet service-level objectives. By defining service-level objectives as optimization goals, the method can focus on identifying resource allocations that maximize performance in alignment with defined service targets.

The above limitations advantageously integrate of service-level objectives into resource deployment strategies to enable the method to quantify the impact of resource allocations on key performance indicators related to user experience and application functionality. This limitation ensures that resource allocation decisions are driven by meeting service-level objectives, leading to deployments that are optimized not only for efficiency but also for delivering services that meet user expectations and service-level agreements.

Example 8: The limitations of Example 7, wherein the service-level objective comprises a threshold latency, and meeting the service-level objective comprises a determination that the latency meets the threshold latency. By defining a threshold latency as the service-level objective, the method focuses on optimizing resource allocations to achieve latency levels that are within acceptable limits. In some cases, the threshold latency service-level objective component may influence the optimization problem solving component by guiding the selection of resource allocation strategies that optimize latency performance to meet the threshold latency. By making latency performance a key optimization criterion, the method can identify resource allocations that minimize latency and ensure that the deployed applications meet the defined threshold latency.

The above limitations advantageously causes the method to focus on optimizing resource allocations specifically for latency-sensitive applications, resulting in deployments that deliver responsive and efficient user experiences, by meeting the specified latency targets This approach allows the method to prioritize latency performance as a critical metric for user experience, ensuring that applications are deployed in configurations that deliver responsive and timely responses to user requests. Also, this approach enables the method to focus on optimizing resource allocations specifically for especially latency-sensitive applications, resulting in deployments that deliver responsive and efficient user experiences by meeting the specified latency targets.

Example 9: The limitations of Example 1, wherein the performance approximation formula is based on applying an estimated workload demand of each service class of a set of service classes of clients to a queuing model that represents the application on a configuration of the computing resource units to estimate a performance metric defined as the service level objective. In some cases, the computer-implemented method may include a workload demand estimation component that considers different service classes of clients to estimate workload demands. In some cases, the performance approximation formula component may interact with the workload demand estimation component to incorporate estimated workload demands of different service classes into the queuing model. In some cases, the performance metric computation component may be influenced by the performance approximation formula based on estimated workload demands of different service classes. By defining the performance metric as the service level objective and estimating it through the queuing model that incorporates workload demands of various service classes, the method can quantitatively measure how well the application meets the specified service level targets for each client type. This approach enables the method to evaluate performance metrics in a granular manner, providing insights into how different service classes are impacted by resource allocations and configuration choices, and facilitating targeted optimization strategies to enhance service quality across diverse client scenarios.

The above limitations advantageously integrate workload demands from multiple service classes into the performance approximation formula to enable the method to capture the complex interactions between client types and application performance on different configurations of computing resource units. By applying estimated workload demands of each service class to a queuing model representing the application on a configuration of computing resource units, the method can create a more detailed and accurate representation of the application's performance under varying client scenarios. This approach allows the method to account for the diverse workload demands of different client types and model how these demands impact the application's performance, enabling more precise estimation of performance metrics based on service level objectives. This limitation enhances the accuracy of performance approximation formulas by considering the unique characteristics and demands of each service class, leading to more comprehensive performance evaluations based on service level objectives.

The illustrative embodiments provide for dynamic computer resource capacity planning and resource allocation scheduling. As used throughout the present disclosure, the term “computing resource unit” refers to any type of computer hardware component, software component, or combination thereof capable of processing computer data. An example computing resource unit may include, but is not limited to, CPUs, GPUs, RAM, SSDs, NICs, FPGAs, ASICS, SANs, APUs, and/or any combination thereof. Although certain embodiments disclosed herein reference GPU characteristics, it is understood that said example is merely illustrative, and characteristics of any other types of computing resource units may be considered as well.

As used throughout the present disclosure, unless otherwise defined by the context, the term “application” refers to any type of software application that may be wholly or partly executed over a computing resource unit. Although certain embodiments disclosed herein reference LLM models and the like, it is understood that the software application may include any type of software application, including any type of machine learning models comprising of various sizes and complexities.

As used throughout the present disclosure, the term inter-token latency (or simply “ITL”) refers to the time taken for a system to process a given input and generate an output or prediction. ITL may be considered as a performance metric in machine learning and artificial intelligence applications, where low latency improves real-time decision-making and responsiveness. Inter-token latency is influenced by factors that may include the complexity of the model, the computational resources available, and the efficiency of the inference process. Reducing ITL is often a key objective in optimizing the performance of machine learning models and ensuring timely responses in applications. Moreover, ITL refers to the delay or time interval between the calculation of two consecutive tokens in a generative model such as a large language model. ITL measures the time taken to compute two consecutive tokens. High inter-token latency leads to slower overall task completion time for a large language model. It is contemplated herein that meeting an ITL requirement may be a type of service-level objective included in a service level agreement.

As used throughout the present disclosure, the term “time to first token” (or simply “TTFT”) refers to a metric that measures how long it takes a language model to generate the first token of a response after receiving a prompt. TTFT may be an indicator of a model's responsiveness and may be especially important for applications that require immediate feedback, such as chatbots, and other real-time systems. Factors that may affect TTFT may include, but are not limited to, Prompt length, model size, TTFT, hardware capabilities and configurations, and/or network configurations. It is contemplated herein that meeting a TTFT requirement may be a type of service-level objective included in a service level agreement.

As used throughout the present disclosure, the term “batch size” refers the number of input samples processed in a single forward and backward pass of a model on a computing resource, e.g., GPU. The batch size represents the quantity of data elements, typically tokens or sequences, that are simultaneously processed in parallel during computations on the GPU. In the context of large language models, the batch size determines the amount of input data processed in each iteration, influencing the efficiency of computations and the utilization of the GPU's parallel processing capabilities. A larger batch size allows for more data to be processed concurrently, potentially reducing inter token latency and improving overall throughput by maximizing the GPU's computational resources. However, selecting an excessively large batch size relative to the GPU's memory capacity can lead to memory constraints and performance degradation. Batch size as a parameter may directly impact a model's computational efficiency, latency, and overall performance as batch size determines the quantity of input data processed in parallel during computations on the GPU.

As used throughout the present disclosure, the term “service level agreement” (or simply “SLA”) and like terms refer to an agreement between a client and a service provider regarding services expected to be provided by the service provider to the client. A typical service level agreement (SLA) between a service provider and a client may include SLA details that may include, for example, expected ITL based on a class of case, customer support window times, and various other terms that define a relationship between a client and a service provider. Accordingly, an SLA may include various service level objectives based on the service provided and the terms of the agreement.

As used throughout the present disclosure, the term “service level objective” (or simply “SLO”) refers to specific, measurable targets that define the expected level of service quality or performance that a system, application, or service should deliver to users. SLOs are typically defined in terms of key performance indicators such as response time, availability, throughput, or error rates. For example, an SLO may specify that the inter-token latency should not exceed a certain threshold to ensure timely data transmission and efficient communication within the system. Different service level classes within a system can have varying corresponding SLOs based on the specific requirements and priorities of each class. Suppose different classes of service may have varying ITL requirements based on their specific performance objectives and priorities. For example, high-priority service classes that handle real-time or mission-critical tasks may have stringent ITL SLOs to ensure rapid processing and timely responses. In contrast, lower-priority service classes that manage background or non-urgent tasks may have more relaxed ITL SLOs, allowing for longer processing times without impacting overall system performance. Consideration of SLOs such as ITL requirements enables efficient resource allocation, prioritization of critical workloads, and optimization of system performance based on the specific requirements of each service class.

As used throughout the present disclosure, the term “resource constrained multi-system environment” (“RCMSE”) refers to a technical or operational setting where multiple interconnected systems or platforms may operate with limited resources, such as for example, computing power, memory, bandwidth, personnel, human resources, time, etc. In an RCMSE, available resources at a present moment in time may be insufficient to meet all demands, cases, and/or service requests, simultaneously, thereby requiring selective management, prioritization, and/or allocation of available resources to ensure effective operation of system processes as well as ensure that predefined service levels are met.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

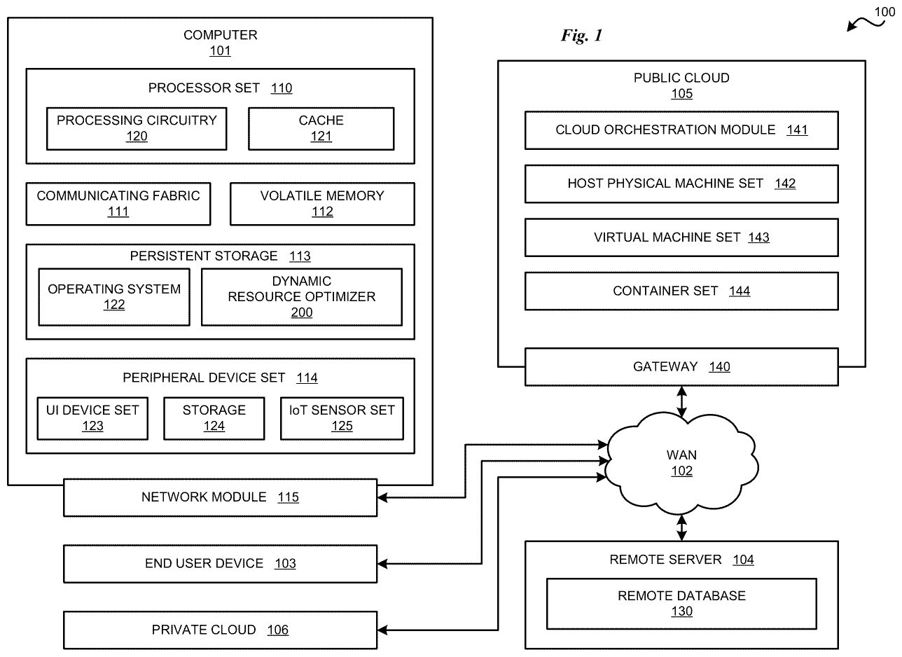

With reference to FIG. 1, this figure depicts a block diagram of a computing environment 100. Computing environment 100 contains an example of an environment for the execution of at least some of the computer code involved in performing the inventive methods, such as a dynamic resource optimizer 200 may be configured to automatically reprioritize a service request queue of a resource constrained multi-system environment based on various derived metrics. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

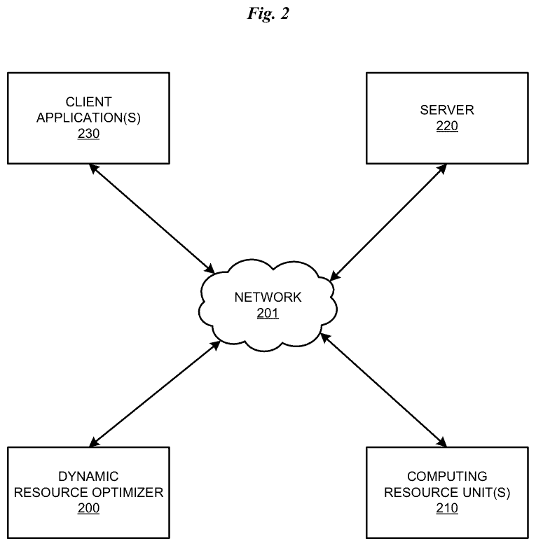

With reference to FIG. 2, this figure depicts a block diagram of an example computing environment in accordance with an illustrative embodiment. In the illustrated embodiment, the computing environment includes the dynamic resource optimizer 200 of FIG. 1.

In an embodiment, the dynamic resource optimizer 200 is configured for optimizing the allocation of computing resources within the system over network 201. The dynamic resource optimizer 200 may include one or more algorithms and heuristics to analyze the workload demands and performance metrics of the computing environment continuously. In an embodiment, dynamic resource optimizer 200 may be configured to estimate future workload demands based on past historical data obtained. In an embodiment, the dynamic resource optimizer 200 is configured to optimize resource utilization efficiency and meet one or more performance objective, such as for example, the Service Level Objectives (SLOs) of the system, by dynamically adjusting the allocation of resources based on real-time data and/or predictions based on past performance data.

In an embodiment, the computing environment also includes a set of computing resource units 210, which may include various heterogenous hardware components such as CPUs, GPUs, accelerators, memory modules, and storage devices. Accordingly, the computing resource units 210 support the execution of client applications 230. The dynamic resource optimizer 200 interacts with the computing resource units 210 by monitoring their utilization levels, performance metrics, and availability. Based on this information, the dynamic resource optimizer 200 dynamically allocates computing resources to different tasks and applications to optimize based on a defined optimization goal (e.g., financial cost, power consumption, etc.).

In an embodiment, the server 220 is configured to host and/or manage the execution of client applications 230. The server 220 interacts with the dynamic resource optimizer 200 to receive resource allocation decisions and instructions on how to distribute computing resources. The server 220 communicates with the set of computing resource units 210 to request and release resources as needed, ensuring that client applications 230 are executed in accordance with the system's performance objectives.

In an embodiment, the set of client applications 230 includes the software programs or services that run on the server 220 and utilize the computing resource units 210 to perform various tasks. In an embodiment, the client applications 230 interact with the dynamic resource optimizer 200 to communicate their resource requirements, performance expectations, and SLOs. By providing feedback to the dynamic resource optimizer 200, the client applications 230 enable the system to adapt its resource allocation strategies to meet the changing demands of different workloads and applications. In an embodiment, the dynamic resource optimizer 200, computing resource units 210, server 220, and client applications 230 collectively form a cohesive computing environment where resources are dynamically optimized to achieve efficient and reliable system performance.

In an embodiment, dynamic resource optimizer 200 decides an allocation state, which comprises for each application and service class pair: (i) type of computing resource unit; (ii) number of computing resource units; and (iii) maximum batch size. Further, the dynamic resource optimizer 200 may be configured to run periodically and consider current allocation state and predicted changes in request demand patterns, to compute the next allocation state of the computing resource units 210. Also, the optimizer may minimize changes in accelerator allocations between current and future target state, by taking into account the transition cost of switching an accelerator between two models. In the illustrated embodiment, the dynamic resource optimizer 200 is configured to reallocate computing resource units 210 based on one or more parameters, metrics, and/or optimization criteria. In an embodiment, the dynamic resource optimizer 200 includes a processor, a memory, and a set of instructions stored on the memory that when executed by the processor cause the dynamic resource optimizer 200 to perform the following example operations described in greater detail herein.

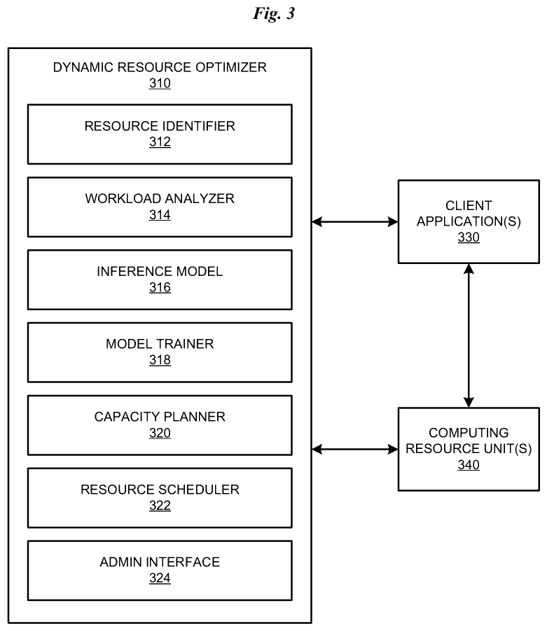

With reference to FIG. 3, this figure depicts a block diagram of an example dynamic resource optimizer in accordance with an illustrative embodiment. In an embodiment, the dynamic resource optimizer 310 includes a software module comprising a plurality of other connected software modules. In an embodiment, the dynamic resource optimizer 310 includes a resource identifier module 312, a workload analyzer module 314, an inference model 316, a model trainer module 318, a capacity planner module 320, a resource scheduler module 322, and an administrator interface module 324.

In an embodiment, the resource identifier module 312 is configured for identifying, categorizing, and storing data related to available computing resources, such as CPUs, GPUs, accelerators, memory units, and any other computing resource units described herein. For example, this data may include information such as the types of accelerators or GPUs present in the cluster, their specifications (such as memory size, memory bandwidth, and processing capabilities), the number of each type of accelerator available, and their current utilization levels. Additionally, the resource identifier module 312 may gather data on other hardware components in the cluster, such as CPUs, memory modules, and storage devices, along with their respective capacities and performance metrics.

In an embodiment, the workload analyzer module 314 receives data related to application characteristics and data from the resource identifier module 312 and analyzes the estimated workload for the system based on different configurations of resources identified. Accordingly, the workload analyzer module 314 module processes information on application characteristics such as model size, KV-cache size, and/or compute intensity obtained related to the client application 330. By considering these application-specific attributes, the workload analyzer module 314 assesses the computational requirements, memory usage patterns, and processing demands of each application of client applications 330 within the system.

In an embodiment, using the data on different configurations of resources identified by the resource identifier module 312, the workload analyzer module 314 conducts workload analysis to evaluate the estimated workload of the client applications 330. This analysis may include simulating the performance of each application on various resource configurations, considering factors such as the number and types of accelerators, memory capacity, and processing capabilities available in the system. Further, these simulations may consider factors, including but not limited to, the number of concurrent users, the types of tasks being performed, and the data processing requirements of the software applications. By assessing the estimated workload under different resource configurations, the workload analyzer module 314 aids in determining the optimal resource allocation strategy to meet performance objectives, such as minimize latency, power consumption, cost, etc.

In an embodiment, the workload analyzer module simulates the execution of software programs on one or more resources identified by the resource identifier module 312 by analyzing historical data, current workload patterns, and performance metrics. In an embodiment, the workload analyzer module 314 collects information on the characteristics of the software programs, such as their computational requirements, memory usage, and input-output patterns. Also, the workload analyzer module 314 gathers data on the identified computing resources of computing resource units 340, including their processing power, memory capacity, and network bandwidth.

In an embodiment, the workload analyzer module 314 defines one or more performance profiles using the execution results to assess the impact of varying workloads on the identified resources. In an embodiment, each performance profile can identify potential bottlenecks, resource constraints, or performance issues that may arise when running specific software programs on the available resources. In an embodiment, the performance characteristics of the models are benchmarked or estimated offline and provided as a set of measurements or a function (e.g., a polynomial) to the solver. By executing software programs on the identified resources, the workload analyzer module can help inference model 316 predict how the system will perform under different workload scenarios.

In an embodiment, the capacity planner module 320 is configured to produces one or more resource allocation strategies. In an embodiment, the resource scheduler module 322 then executes the resource allocation decisions based on the recommendations from the capacity planner module 320.

In an embodiment, the administrator interface module 324 provides a user interface for system administrators to monitor and adjust resource allocation settings based on system performance, requirements, optimization goals, and/or other criteria. In an embodiment, through the interface, an administrator can specify objectives such as minimizing the overall cluster cost, reducing power consumption, maximizing the meeting of Service Level Objectives (SLOs), or achieving other performance targets, as well as can set any parameters, constraints, and priorities that are desired. In an embodiment, administrator interface module 324 is configured to input optimization goals and preferences, such as cost constraints, performance targets, and resource utilization thresholds. Administrators can define key metrics for optimization, specify the importance of different objectives, and set constraints based on budgetary considerations, operational constraints, and/or service level agreements.

Embodiments of the present disclosure includes optimization based on spot pricing of resources (e.g., GPUs) and/or spot pricing of inferencing requests. In an embodiment, resource allocation for deploying computer applications can consider spot pricing to optimize cost efficiency and performance. Spot pricing refers to a dynamic pricing model where resources are allocated based on real-time supply and demand, allowing users to bid on available resources at fluctuating prices. By monitoring spot pricing of GPUs and inference requests, embodiments of the present disclosure strategically allocate resources to minimize costs while meeting performance requirements and/or other service level objectives. In some cases, the system can leverage lower spot prices for GPUs during periods of low demand and adjust resource allocation based on the cost of inference requests to maximize cost savings, in terms of financial cost, power consumption cost, etc.

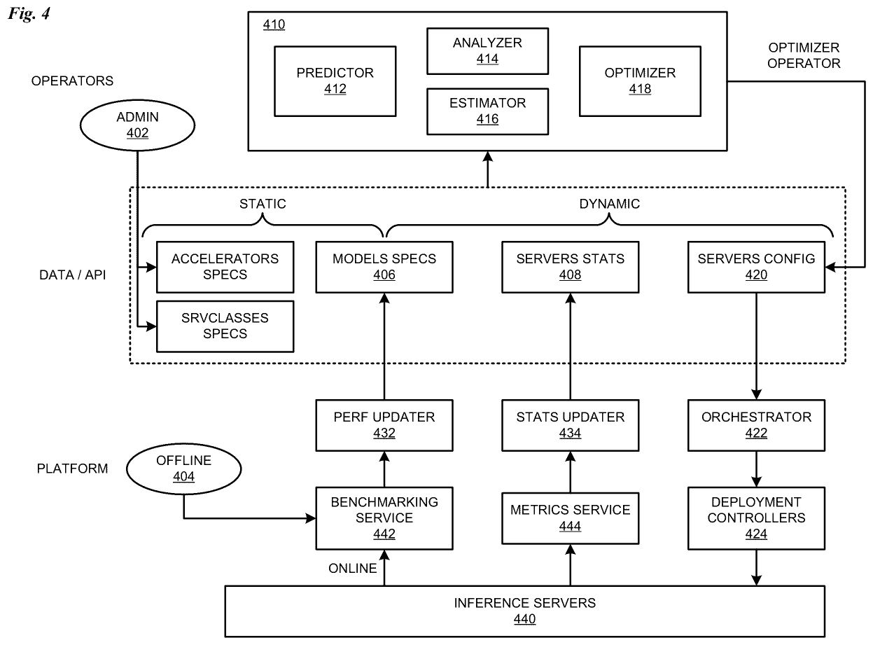

With reference to FIG. 4, this figure depicts a block diagram of an example system architecture in accordance with an illustrative embodiment. In an embodiment, the system includes dynamic resource optimizer 200 of FIGS. 1 and 2 and/or dynamic resource optimizer 310 of FIG. 3. In an embodiment, the optimizer operator module 410 includes a predictor module 412, an analyzer module 414, an estimator module 416 and an optimizer module 418.

In an embodiment, the optimizer operator 410 receives data from various interconnected data sources and/or applications via various interfaces, as shown in the example illustrative embodiment. In an embodiment, an administrator 402 defines accelerator specifications and service class specifications. Further, the optimizer operator module 410 receives data related to model specifications 406, server statistics 408, and server configurations 420, combined with the static accelerator specification data and service class specification data, to predict performance of one or more hardware configurations, as described in greater detail herein.

In an embodiment, the optimizer 418 optimizes resource allocation based on a cost function to meet a defined performance objective. In an embodiment, the dynamic resource optimizer 410 communicates with the server configuration 420 to release a portion of computing resource units for deployment of applications. In an embodiment, the orchestrator 422 coordinates the deployment and management of resources within the cluster while deployment controllers 424 oversee the deployment of applications and manage the allocation of resources to meet workload demands and/or performance objectives.

In an embodiment, the inference servers 440 execute inference tasks corresponding to different models/applications. In an embodiment, offline services 404 may include benchmarking services 442 that provide performance data to evaluate performance of different configurations. In an embodiment, benchmarking performance testing is performed offline, as described in greater detail herein. In some other embodiments, performance testing may be performed as part of an online service. In an embodiment, the system benchmarks the execution of models and then refines its performance model for making a decision to effectively cause the system to auto-tune. In an embodiment, the system collects actual performance numbers, compares the actual performance numbers to inferenced estimates, and updates the model as inferences are generated. Further, the metrics analysis service 444 collects and analyzes performance metrics to assess system health and identify areas for optimization. The status updater 434 ensures that real-time status updates are communicated across the system, facilitating coordination and decision-making. The performance data updater 432 continuously updates performance data to inform resource allocation decisions and optimize system performance.

In an embodiment, the optimizer 418 receives the current system (or an anticipated system state) and optimizes the resource allocation to achieve an optimal target state according to the optimization target. In an embodiment, the predictor module 412 is configured to generate predictions regarding future traffic and request arrival patterns. In an embodiment, the optimizer 418 leverages results output by the predictor to optimize resource allocations under a current set of the constraints at a present moment in time, while simultaneously considering the future state prediction.

In an embodiment, the optimizer 418 uses benchmarking information while selecting the batch size that should be used in order to meet the target inter token latency. Embodiments of the present disclosure include estimating the inter-token latency (ITL) of a model when using a particular batch size.

In an embodiment, the optimizer solves a fully specified optimization problem expressed as a formula. In some such embodiments, the process may include conversion of hardware-application pairs on accelerators into a polynomial representing pairs of models on accelerators, and performing curve fitting to determine an optimal resource allocation. In such an embodiment, the optimizer is not tasked with a big numeric space search, but instead may be tasked with executing a closed function search.

Embodiments include representing the ITL as a polynomial for a specific model on a specific computing resource configuration. Accordingly, each model/GPU pair may be associated with a unique polynomial that captures the relationship between the batch size, computational resources, and ITL. In an embodiment, the polynomial function is used to model the ITL as a function of the batch size and other relevant parameters specific to the model and GPU configuration. By fitting the polynomial to empirical data obtained through performance profiling and experimentation, the system determines the ITL based on the chosen batch size and GPU configuration.

In an embodiment, the polynomial equation may include an expression that includes coefficients representing the impact of the batch size on the ITL, as well as any other factors that influence latency in the specific model/GPU pair. By analyzing the coefficients and terms of the polynomial, and by utilizing polynomials to represent the ITL for specific model/GPU pairs, embodiments of the present disclosure estimate and optimize the inter-token latency based on the chosen batch size and computing resource configuration.

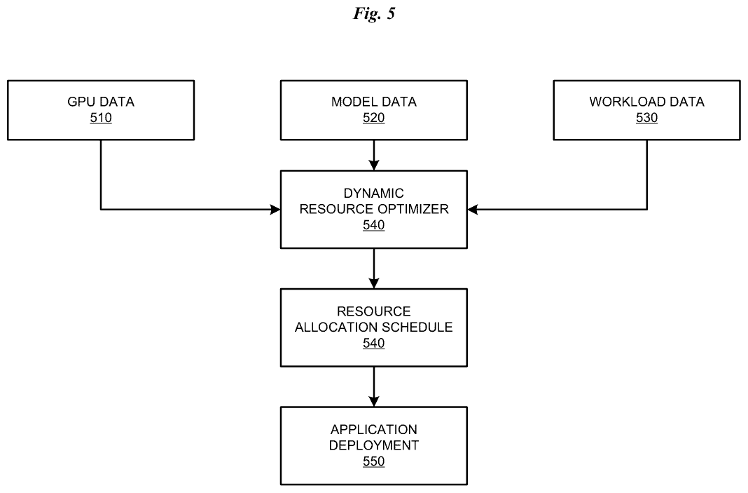

With reference to FIG. 5, this figure depicts a block diagram of an example process of dynamic capacity planning and resource allocation in accordance with an illustrative embodiment. In the illustrated embodiment, the dynamic resource optimizer 540 may include dynamic resource optimizer 200 of FIGS. 1 and 2, dynamic resource optimizer 310 of FIG. 3, and/or dynamic resource optimizer 410 of FIG. 4.

In an embodiment, the dynamic resource optimizer 540 receives GPU data 510, model data 520, and workload data 530 to determine an optimal resource allocation schedule 550. In an embodiment, at block 550, the process deploys one or more applications to a portion of available computing resources identified as an optimal configuration of computer resources to meet a specified performance and/or optimization goal.

In an embodiment, the GPU data may include, but is not limited to, type of GPU, processing capabilities in terms of memory size, memory bandwidth, and theoretical floating-point operations per second (TFLOPS). Also, GPU data may include performance metrics related to the GPU's utilization, temperature, power consumption, and efficiency. Also, GPU data may include other specifications, such as architecture, release date, current price, historical price, predecessor models, successor models, etc.

In an embodiment, the model data 520 may include specific attributes and properties that define the computational requirements, complexity, and behavior of a machine learning or data processing model used within an application. Examples of these characteristics may include, but are not limited to, the size of the model, which indicates the number of parameters or features that the model needs to process during inference or training, the KV-cache size, representing the amount of memory allocated for key-value, inter-token latency based on batch size, communication and compute intensity per token, reflecting the level of data exchange and computational workload required for processing individual data units within the model, as well as any other characteristics associated with the computational and/or memory demands for deploying an application.

In an embodiment, the workload data 530 may include information and characteristics of the computational tasks and processing requirements associated with each application within a compute cluster environment. Workload data may include details such as the computational intensity, memory usage patterns, input-output operations, and processing time of each application. Also, workload data may include the frequency of task execution, the volume of data processed, and the communication requirements between different components of the application. By analyzing workload data for each application, dynamic resource optimizer 540 gains insights into the resource demands, performance profiles, and operational needs of individual applications. This information aids optimizing resource allocation, scheduling tasks, and ensuring that the compute cluster(s) meet workload demands of different applications while adhering to defined Service Level Objectives (SLOs).

In an embodiment, generating a performance profile for each configuration includes considering both static variables and dynamic variables to assess system performance. Static variables may include static application characteristics, such as model size, KV-cache size, and compute intensity, which remain constant over time. Other static variables may include static hardware characteristics, including GPU types, memory size, and processing capabilities. Dynamic variables may include historical changes in workload demand observed based on market trends, usage patterns, and seasonal variations. By analyzing historical data, the system can identify trends, patterns, and peak usage periods to anticipate future workload demands accurately. Further, real-time workload demand changes provide immediate insights into current system requirements, enabling adaptive resource allocation in response to fluctuating workloads. By considering both static and dynamic variables in generating performance profiles for each configuration, the system can adapt to changing conditions to optimize resource allocation in dynamic computing environments.

In an embodiment, the process depicted with reference to FIG. 5 dynamically adjusts resource allocation based on predictions and real-time changes in workload demand. Capacity planning may involve forecasting and preparing for long-term projections of system demands over an extended period, typically spanning months or even years, which entails analyzing historical data, growth trends, and business requirements to estimate future resource needs accurately. Capacity planning aims to ensure that the system has sufficient resources to handle anticipated workloads, prevent performance bottlenecks, and support business objectives effectively over the long term. On the other hand, resource allocation may occur in real-time or near real-time, involving the dynamic assignment of resources to meet immediate workload demands, often within seconds or fractions of a second, to optimize system performance in response to changing workload patterns.

In an embodiment, the dynamic resource optimizer 540 includes a scheduler for optimizing resource allocation in an inference cluster designed to allocate resources efficiently to multiple LLM models while meeting latency Service Level Objective (SLO) constraints. The system considers as inputs factors such as performance estimation for each LLM model on different accelerator types, latency SLOs (ITL, TTFT, etc.) for each LLM model and service class, and the current request intensity for each service class. Further, the scheduler produces outputs including the number of accelerators of a specific type to allocate to each LLM model, a subset of these accelerators to assign to each traffic class, the operating batch size for each traffic class, and the minimization of the total cost of the cluster based on the per-minute cost of each accelerator type. Further, by dynamically adjusting the allocation of accelerators, batch sizes, and resource assignments based on real-time workload demands and latency constraints, the system ensures efficient resource utilization and cost-effective operation of the inference cluster.

In an embodiment, the dynamic resource optimizer 540 includes queuing model, such as G/G/m, to model GPU behavior within the cluster. The queuing model helps predict system performance, analyze resource utilization, and optimize task scheduling based on queuing theory principles. In an embodiment, the dynamic resource optimizer 540 utilizes a performance approximation formula derived from empirical benchmarking data to estimate the performance of each LLM model on a given accelerator type.

In an embodiment, the dynamic resource optimizer 540 includes a solver that solves a constrained optimization problem to determine the optimal resource allocation strategy. By formulating the resource allocation challenge as an optimization problem, the solver can consider various constraints, objectives, and variables to generate an optimal resource allocation plan that minimizes total cost while meeting latency SLO constraints. This iterative optimization process enables the system to adapt to changing workload demands, optimize resource utilization, and ensure that performance targets are met within the inference cluster.

In an embodiment, the dynamic resource optimizer 540 may be configured to control a compute cluster environment comprising multiple servers and a heterogeneous hardware setup that includes various accelerator/GPU types with differing processing capabilities such as memory size, memory bandwidth, and TFLOPS, etc. The compute cluster may be configured to deploy multiple applications, each application characterized by unique attributes, including but not limited to, model size, KV-cache size, and communication/compute intensity per token. Additionally, each application may be associated with a specific class of service, where each class is defined by target Service Level Objectives (SLOs) such as inter-token latency and time to first token.

In an embodiment, the dynamic resource optimizer is configured to produce an optimal number of GPUs, GPU types, and batch sizes to allocate to each application. This optimization process takes into account the specific characteristics of each application, including model size, KV-cache size, and compute intensity, as well as the associated class of service with defined SLOs. By considering the processing capabilities of the available accelerator/GPU types and the workload demands of each application, the optimizer is able meet the SLOs of all traffic classes within the elastic compute cluster.

Further, in addition to ensuring that each application receives the appropriate number and type of GPUs, as well as optimal batch sizes, to meet its performance requirements and adhere to the defined SLOs, the dynamic resource optimizer 540 considers the cost to implement a particular hardware configuration. For example, it may be the case that a small GPU is cheaper than a larger GPU, but the smaller GPU may have a lower throughput and higher latency than the larger, more expensive GPU. In contrast, the larger GPU may have a higher throughput and a lower latency than the smaller GPU, but may be more expensive to deploy. Accordingly, there exists an optimum configuration that comprises the most throughput, least latency, per dollar (or per unit power consumption) cost as defined by a demand curve. In an embodiment, the optimizer may receive a priori measurements of demand into consideration when producing an optimal cluster configuration to deploy the set of applications, as described in greater detail herein. In an embodiment, the dynamic resource optimizer 540 is configured to solve a global optimization problem to determine an optimal clusters of resources deploy a set of application of different characteristics and computational demands.

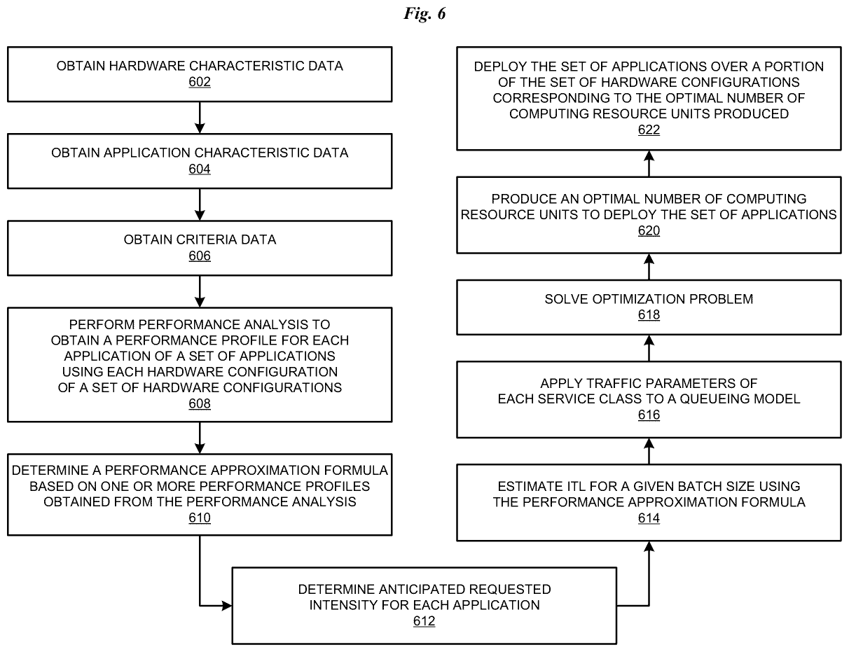

With reference to FIG. 6, this figure depicts a flowchart of an example process of computer resource capacity planning, in accordance with an illustrative embodiment. In an embodiment, the dynamic resource optimizer 200 of FIGS. 1 and 2, dynamic resource optimizer 310 of FIG. 3, dynamic resource optimizer 410 of FIG. 4, and/or dynamic resource optimizer 540 of FIG. 5 carries out the process.

In an embodiment, at step 602, the process obtains a set of hardware characteristic data corresponding to a set of computing resource units. In an embodiment, the process includes obtaining a list of possible GPU types and associated characteristics, including but not limited to, memory capacity, memory bandwidth, and theoretical floating-point operations per second (TFLOPS). Accordingly, this information provides insight for understanding the capabilities and limitations of each computing resource unit type, which may be used to optimize resource allocation.

In an embodiment, at step 604, the process obtains application characteristic data corresponding to a set of software applications. In an embodiment, the process includes obtaining a list of LLMs and associated characteristics, including but not limited to, parameters, number of layers, dimensions, and cache sizes. Accordingly, the application characteristic data may be used in part for determining the computational requirements and performance characteristics of each LLM model, which may be used to optimize the allocation of GPUs and/or batch sizes.

In an embodiment, the process obtains characteristics data via polynomial representation representing inter-token latency (ITL) for each application and hardware configuration. In an embodiment, the performance characteristics of the application and computer resource pairs may be benchmarked or estimated offline and provided as a set of measurements or a function (e.g., a polynomial) to the solver. Embodiments include representing the ITL as a polynomial for a specific model on a specific computing resource configuration. Accordingly, each pair may be associated with a unique polynomial that captures the relationship between the batch size, computational resources, and ITL. Further, conversion of hardware-application pairs on accelerators into a polynomial representing pairs of models on accelerators enables performing curve fitting to determine an optimal resource allocation.

In an embodiment, at step 606, the process obtains criteria data corresponding to one or more sets of criteria. In an embodiment, the process includes obtaining Service Level Objective (SLO) targets for each LLM and service class. In an embodiment, these targets define the performance metrics that need to be met for each LLM model and service class, which may provide a benchmark for evaluating the effectiveness of the resource allocation strategy.

In an embodiment, at step 608, the process includes performing a performance analysis to obtain a performance profile for each application of a set of application to be executed on each possible hardware configuration of a set of hardware configurations. In an embodiment, the process includes profiling the performance of each LLM model on each accelerator, capturing latency (e.g., ITL) and throughput as a function of batch size. In an embodiment, the performance profile and the performance of each LLM model is affected by different batch sizes on various accelerator types.

In an embodiment, at step 610, the process includes deriving an approximation formula defining latency vs batch size performance based on the profiling data obtained in the previous step 608. The approximation formula enable the estimation of ITL for a given batch size, facilitating the prediction of performance under different workload scenarios.

In an embodiment, at step 612, the process includes obtaining the anticipated request intensity for each service class and LLM model. In an embodiment, at step 614, the process includes computing the latency for each configuration utilizing the performance approximation formula to estimate ITL for a given batch size, taking into account the anticipated request intensity for each service class and LLM model. In an embodiment, at step 612, the process involves predicting the request intensity for each service class and LLM model based on recent request arrival measurements. In an embodiment, at step 616, the process includes applying the traffic parameters of each service class to a queuing model that represents the LLM on an computing resource instance type to estimate the TTFT latency.

In an embodiment, at step 618, the process includes constructing and solving an optimization problem representing the set of possible hardware and software applications, with the objective of minimizing the overall cluster cost while ensuring that the SLOs of all traffic classes are met. In an embodiment, step 618 includes an iterative optimization process that includes repeatedly using queuing models and performance formulas to produce updated resource allocation decisions. Accordingly, in an embodiment, solving the optimization problem includes minimizing the overall cluster cost while ensuring that the SLOs of all traffic classes are met.

In an embodiment, at step 620, the process includes producing an optimal number of computing resource units to deploy the applications. The optimal number of computing resource units may include a combination GPU types and batch sizes to allocate to each application (e.g., model-class pair), ensuring that no SLO violations occur in any service class. In cases where SLO violations occur, the least important classes of service are affected first, ensuring that critical service levels are maintained. In some cases, an administrator may define an acceptable threshold and/or criteria for meeting SLO targets. By following the optimization process and considering the performance characteristics of each LLM model and service class, the process provides the most cost-effective resource allocation strategy that meets the performance and latency requirements of the system. In an embodiment, at step 622, the process deploys the set of applications over a portion of the set of hardware configurations corresponding to the optimal number of computing units produced.

As described above, in an embodiment, the process periodically repeats a portion of the preceding steps to adapt to changing workload conditions and optimize resource allocation continuously. By following this iterative approach, the system can dynamically adjust resource allocation based on real-time performance data and demand patterns, ensuring optimal performance and cost-effectiveness over time.

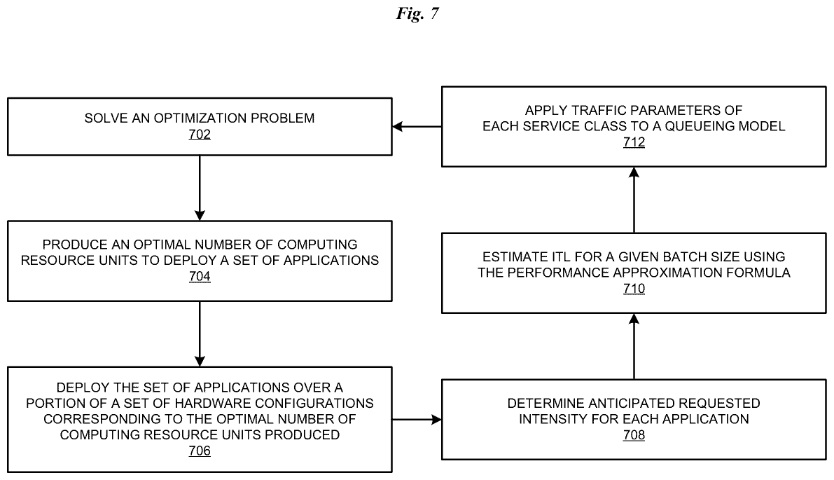

With reference to FIG. 7, this figure depicts example process for dynamic computer resource allocation optimization in accordance with an illustrative embodiment. In an embodiment, the dynamic resource optimizer 200 of FIGS. 1 and 2, dynamic resource optimizer 310 of FIG. 3, dynamic resource optimizer 410 of FIG. 4, and/or dynamic resource optimizer 540 of FIG. 5 carries out the process. In an embodiment, the process includes some or all of steps of process 600, even if not explicitly mentioned.

In an embodiment, the process 700 may configured to be executed or begin according to a particular start state. In an embodiment, the start state may include a state corresponding to the current workload. In an embodiment, the start state may include a state corresponding to a pre-configured minimum number of GPUs per model. In an embodiment, at step 702, the process solves an optimization problem to determine an optimal allocation of computing resource units to deploy a set of applications. In an embodiment, the process begins with problem formulation, where the objective function and constraints of the optimization problem are defined. In an embodiment, the objective function aims to minimize the overall cost of the clusters, considering factors such as the per-minute cost of each accelerator type, resource allocation decisions, and latency SLO constraints. Constraints may include limitations on resource availability, performance targets, and other system requirements.

Further, decision variables may be identified as parameters that can be adjusted to optimize the objective function. These variables may include the number of accelerators of each type allocated to each LLM model, the subset of accelerators assigned to each traffic class, and the operating batch size for each traffic class. An appropriate optimization algorithm may be selected to solve the global optimization problem.

In an embodiment, the optimization problem is configured within a selected solver, specifying the objective function, decision variables, constraints, and any additional parameters desired for optimization. In an embodiment, the solver is configured to iteratively explore the solution space and identify the optimal resource allocation plan that minimizes overall cost while meeting latency SLO constraints, using one or more techniques are to search for the global optimum, considering the interactions between decision variables and constraints.

In an embodiment, at step 704 the process produces an optimal number of computing resource units to deploy a set of applications. At step 706, the process deploys the set of applications over a portion of a set of hardware configurations corresponding to the optimal number of computing units produced.

In an embodiment, at step 708, the process determines an anticipated requested intensity for each application. In an embodiment, the iterative process of optimizing resource allocation in an inference cluster includes the repeated determination of anticipated request intensity for each application. Accordingly, an iterative approach involves continuously assessing and updating the anticipated request intensity for each application based on historical data, real-time workload patterns, and/or changing system requirements. By repeatedly determining the anticipated request intensity, the system can adapt to fluctuations in workload demands, adjust resource allocation strategies, and optimize performance based on the dynamic nature of the inference cluster environment.

In an embodiment, at step 710, the process estimates a performance metric for one or more configurations for a given batch size. In an embodiment, the process includes computing the latency for each configuration utilizing a performance approximation formula to estimate the batch size that achieves an ITL. In an embodiment, the process considers the iteratively updated anticipated request intensity for each service class and LLM model. In an embodiment, at step 712, the process includes applying the traffic parameters of each service class to a queuing model that represents the LLM on a computing resource instance type to estimate the TTFT latency. In an embodiment, the process repeats again beginning at step 710.

Embodiments of the present disclosure leverage a combination of factors to dynamically compute an optimal configuration of hardware components to deploy one or more applications. Embodiments of the present disclosure may consider cost of deployment as a factor in determination of an optimal configuration to deploy one or more applications, as well as may consider various other features, including but not limited to, hardware characteristics, application characteristics, batch size, varying changes in demand, optimization goals, etc., and various other features not currently considered or leveraged into capacity planning and resource allocation solutions. In an embodiment, the process includes establishing, training, and/or fine tuning one or more deep learning models to discover historical trends related to workload demand and inference future workload demands.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating a performance profile for at least one configuration of a set of possible configurations, the at least one configuration representing a pairing between an application and a portion of computing resource units for deployment of the application;
computing a performance approximation formula based on one or more performance profiles generated;
computing a performance metric for the at least one configuration of the set of possible configurations based on the performance approximation formula;
constructing an optimization problem representing the at least one configuration of the set of possible configurations;
solving the optimization problem according to a defined optimization goal and the performance metric of the at least one configuration;
producing, based on results of solving the optimization problem, an optimal number of computing resource units to deploy an application of a set of applications; and
deploying the over a portion of the set of possible configurations corresponding to the optimal number of computing resource units produced for that application.

2. The computer-implemented of claim 1, wherein the defined optimization goal comprises minimizing deployment cost of the application.

3. The computer-implemented of claim 1, wherein the defined optimization goal comprises minimizing power consumption corresponding to deployment of the application.

4. The computer-implemented method of claim 1, wherein the generating the performance profile for the at least one configuration of the set of possible configurations is based in part on an estimated workload demand corresponding to the application.

5. The computer-implemented method of claim 4, wherein the estimated workload demand is based in part on a predicted workload demand change.

6. The computer-implemented method of claim 5, wherein the predicted workload demand change is obtained by iteratively analyzing a real-time workload demand corresponding to the application.

7. The computer-implemented method of claim 1, wherein producing the optimal number of computing resource units to deploy the application is based on meeting a service-level objective.

8. The computer-implemented method of claim 7, wherein the service-level objective comprises a threshold latency, and meeting the service-level objective comprises a determination that a latency meets the threshold latency.

9. The computer-implemented method of claim 7, wherein the performance approximation formula is based on applying an estimated workload demand of at least one service class of a set of service classes of clients to a queuing model that represents the application on a configuration of the computing resource units to estimate a performance metric defined as the service level objective.

10. A computer program product comprising one or more computer readable storage media, and program instructions collectively stored on the one or more computer readable storage media, the program instructions executable by a processor to cause the processor to perform operations comprising:
generating a performance profile for at least one configuration of a set of possible configurations, the at least one configuration representing a pairing between an application and a portion of computing resource units for deployment of the application;
computing a performance approximation formula based on one or more performance profiles generated;
computing a performance metric for the at least one configuration of the set of possible configurations based on the performance approximation formula;
constructing an optimization problem representing the at least one configuration of the set of possible configurations;
solving the optimization problem according to a defined optimization goal and the performance metric of the at least one configuration;
producing, based on results of solving the optimization problem, an optimal number of computing resource units to deploy the application; and
deploying the application over a portion of the set of possible configurations corresponding to the optimal number of computing resource units produced.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, wherein the defined optimization goal comprises minimizing deployment cost of the application.

14. The computer program product of claim 10, wherein the defined optimization goal comprises minimizing power consumption corresponding to deployment of the application.

15. The computer program product of claim 10, wherein the generating the performance profile for the at least one configuration of the set of possible configurations is based in part on an estimated workload demand corresponding to the application.

16. The computer program product of claim 15, wherein the estimated workload demand is based in part on a predicted workload demand change.

17. A computer system comprising a processor and one or more computer readable storage media, and program instructions collectively stored on the one or more computer readable storage media, the program instructions executable by the processor to cause the processor to perform operations comprising:
generating a performance profile for at least one configuration of a set of possible configurations, the at least one configuration representing a pairing between an application and a portion of computing resource units for deployment of the application;
computing a performance approximation formula based on one or more performance profiles generated;
computing a performance metric for the at least one configuration of the set of possible configurations based on the performance approximation formula;
constructing an optimization problem representing the at least one configuration of the set of possible configurations;
solving the optimization problem according to a defined optimization goal and the performance metric of each configuration;
producing, based on results of solving the optimization problem, an optimal number of computing resource units to deploy the application; and
deploying the application over a portion of the set of possible configurations corresponding to the optimal number of computing resource units produced.

18. The computer system of claim 17, wherein the defined optimization goal comprises minimizing deployment cost of the application.

19. The computer system of claim 17, wherein the defined optimization goal comprises minimizing power consumption corresponding to deployment of the application.

20. The computer system of claim 17, wherein the generating a performance profile for the at least one configuration of a set of possible configurations is based in part on an estimated workload demand corresponding to the application.
